(19) United States
(12) Patent Application Publication
(10) Pub. No.: US 2013/0026844 A1
(43) Pub. Date: Jan. 31, 2013

(54) PHOTOVOLTAIC GENERATION SYSTEM, POWER CONVERSION DEVICE, AND COLLECTOR BOX

(71) Applicants: Hirofumi Mitsuoka, Osaka-shi (JP); Takuji Tanigami, Osaka-shi (JP)

(72) Inventors: Hirofumi Mitsuoka, Osaka-shi (JP); Takuji Tanigami, Osaka-shi (JP)

(73) Assignee: Sharp Kabushiki Kaisha, Osaka (JP)

(21) Appl. No.: 13/640,898

(22) PCT Filed: Mar. 25, 2011
(86) PCT No.: PCT/JP2011/057312

§ 371 Date: Oct. 12, 2012

(30) Foreign Application Priority Data
Apr. 12, 2010 (JP) 2010-091454

(51) Int. Cl. H02J 3/38

(52) U.S. Cl. 307/82

(57) ABSTRACT

A photovoltaic generation system includes: a solar cell array that includes a plurality of solar cell modules; a collector portion that collects power from the solar cell array; a power control portion that is connected to the collector portion and includes a power conversion portion which converts first power from the solar cell array into second power; a first electric wiring that connects the collector portion and the power control portion to each other; a first connection terminal that is supplied with the first power from the solar cell array; and a first switch portion that shuts off output from the solar cell array for the power conversion portion; wherein an alternative power control portion is connectable to the first connection terminal.

### TECHNICAL FIELD

The present invention relates to a photovoltaic generation system, a power conversion device, and a collector box.

### BACKGROUND ART

In recent years, photovoltaic generation is attracting attention as power generation that does not emit carbon dioxide and is environmentally friendly. Owing to this, prices of a solar cell module are declining, and a photovoltaic generation system is finding its wide applications extending from a power back-up means for home use to massive industrial generation. Further, in recent years, a photovoltaic generation system is also used for a photovoltaic generation plant.

Besides, in the above photovoltaic generation system, to supply power generated by the solar cell module to a general a.c. load for home use, a power conversion device for converting the d.c. power into a.c. power is disposed.

As the power conversion device, a power conversion device having a different rated output is used depending on its use. For example, in a photovoltaic generation system for general home use, a power conversion device having a rated output of about 3 kW is used. Here, as the power conversion device having the rated output of 3 kW, for example, a power conversion device described in a patent document 1 is known.

On the other hand, in industry, for example, a power conversion device having a rated output of 100 kW or 250 kW is used. And, owing to the widespread use of the photovoltaic generation system, a power conversion device having the rated output of 100 kW or 250 kW is also put in the market.

### CITATION LIST

### Patent Literature

PLT1: JP-A-2008-92628

### SUMMARY OF INVENTION

### Technical Problem

It is said that the life of a solar cell module is generally 20 years or longer, however, the nominal life of a power conversion device which is a peripheral device is about 10 years. Because of this, in a case of exceeding 10 years, there is a case where maintenance of the power conversion device becomes necessary. In other words, it is highly possible that after a photovoltaic generation system is installed, an opportunity for the maintenance of the power conversion device comes before replacement of the solar cell module.

Here, as described above, the power conversion device for general home use has the rated output of about 3 kW and its weight is about 30 kg, accordingly, it is movable by two workers. Because of this, in a case where the maintenance becomes massive, it becomes possible to replace it with a new power conversion device.

On the other hand, in a case of a photovoltaic generation plant, it is necessary to keep power quality, accordingly, it is necessary not to stop power generation as long as possible. Because of this, speedy fixing becomes necessary, but there is a case where the fixing needs a whole day or more. In this case, like in general home use, a measure is conceivable, in which the power conversion device itself is replaced.

However, as for the power conversion device for industry and a photovoltaic generation plant, as described above, the rated output is 100 kW or 250 kW, and the weight is about 1 t or more. Because of this, the replacement of the device itself is very hard. Besides, such power conversion device has the large rated output, accordingly, a cable around the power conversion device also becomes thick to be about 150 sq, and connection and removal working of the cable also becomes physically hard. Further, the cable is subjected to a d.c. voltage for a long time, accordingly, there is a case where the removal becomes hard thanks to time-dependent change.

The present invention has been made to solve the above problems, and it is an object of the present invention to provide a photovoltaic generation system that is excellent in maintainability, a power conversion device and a collection box that are used for the photovoltaic generation system.

### Solution to Problem

To achieve the above object, a photovoltaic generation system according to a first aspect of the present invention includes: a solar cell array that includes a plurality of solar cell modules; a collector box that collects power from the solar cell array; a power conversion device that is connected to the collector box and includes a power conversion portion which converts d.c. power from the solar cell array into ac power; a first electric wiring that connects the collector box and the power conversion device to each other; a first connection terminal that is supplied with the d.c. power from the solar cell array; and a first switch that shuts off output from the solar cell array for the power conversion portion; wherein an alternative power conversion device is connected to the first connection terminal.

In the photovoltaic generation system according to the first aspect, as described above, by disposing the first switch and putting the first switch into an opened state, it is possible to shut off the output from the solar cell array for the power conversion portion. Besides, by disposing the first connection terminal and connecting the alternative power conversion device to the first connection terminal, it is possible to change a route for the d.c. power from the solar cell array to the alternative power conversion device. In other words, it is possible to make the alternative power conversion device perform power conversion which the power conversion device should perform. According to this, it is possible to perform maintenance working of the power conversion device without stopping power generation at the photovoltaic generation system.

Besides, in the first aspect, according to the above structure, it is possible to perform the maintenance working without removing the first electric wiring that connects the collector box and the power conversion device to each other.

Here, in a photovoltaic generation system for industry and a photovoltaic generation plant and the like, a power conversion device having a large rated output is used and the power conversion device having a large rated output has a weight of about 1 t or more, accordingly, it becomes very hard to replace the device itself. However, in the photovoltaic generation system according to the first aspect, as described above, without replacing the device itself and without removing the first electric wiring that connects the collector box and the power conversion device to each other, it is possible to perform the maintenance working, accordingly, it is possible to improve the maintainability.

Here, in a case where the above photovoltaic generation system according to the first aspect is used for industry or a photovoltaic generation plant, especially, it is possible to improve the maintainability; however, even in a case of general home use, it is possible to improve the maintainability.

In the above photovoltaic generation system according to the first aspect, it is preferable that the collector box and the power conversion device are both structured to include a first terminal to which the first electric wiring is connected; and it is preferable that the first connection terminal and the first switch are both disposed in at least one of the collector box and the power conversion device.

In this case, preferably, the power conversion device includes the first connection terminal, the first terminal and the first switch. According to this structure, it is possible to easily improve the maintainability of the photovoltaic generation system.

In the structure in which the above power conversion device includes the first connection terminal, the first terminal and the first switch, it is preferable that the first terminal of the power conversion device is connected to the first connection terminal; and the first connection terminal is connected to the power conversion portion via the first switch.

In the above photovoltaic generation system according to the first aspect, it is possible to structure both of the collector box and the power conversion device to include the first terminal to which the first electric wiring is connected. At this time, the first terminal may be structured to double as the first connection terminal.

In the above photovoltaic generation system according to the first aspect, a structure may be employed, in which the collector box includes the first connection terminal; and the power conversion device includes the first switch that shuts off the output from the solar cell array for the power conversion portion.

In the above photovoltaic generation system according to the first aspect, it is also possible to employ a structure, in which the collector box includes a first terminal to which the first electric wiring is connected, the first connection terminal and the first switch; and the first connection terminal is connected to the first terminal via the first switch.

In the above photovoltaic generation system according to the first aspect, the first connection terminal may be disposed between the collector box and the power conversion device, and connected to the power conversion portion via the first switch.

In the above photovoltaic generation system according to the first aspect, it is also possible to structure the first switch to include a changeover switch that changes a supply destination, to which the d.c. power from the solar cell array is supplied, to the power conversion portion or to the first connection terminal. According to this structure, a state, in which the solar cell array and the power conversion portion are connected to each other, is a state in which the d.c. power from the solar cell array is not supplied to the first connection terminal, accordingly, it is possible to safely connect the alternative power conversion device to the first connection terminal. And, thanks to the changeover of the switch portion, it is possible to shut off the output from the solar cell array for the power conversion portion and to supply the d.c. power to the first connection terminal, accordingly, it is possible to make the alternative power conversion device perform the power conversion that the power conversion device should perform.

In the above photovoltaic generation system according to the first aspect, it is preferable that the power conversion device is structured to include a second terminal as an a.c. output terminal that is connected to an output side of the power conversion portion. In this case, it is more preferable that the photovoltaic generation system according to the first aspect further includes a second connection terminal that is connected to the second terminal. According to this structure, by connecting the alternative power conversion device to the second connection terminal as well, it is possible to perform the maintenance working of the power conversion device without stopping the power generation at the photovoltaic generation system.

In this case, it is preferable that the photovoltaic generation system according to the first aspect further includes a second switch that is connected to the second terminal. According to this structure, by putting the second switch into an opened state, it is possible to surely separate electrically the power conversion portion of the power conversion device from the solar cell array. According to this, it is possible to more safely perform the maintenance working.

In the above structure in which the power conversion device has the second terminal, it is also possible to employ a structure in which the power conversion device includes the second connection terminal. In this case, it is preferable that the second terminal is connected to the power conversion portion via the second connection terminal.

In the above structure in which the power conversion device has the second terminal, it is possible to employ a structure in which the power conversion device includes the second connection terminal and the second switch that is connected to the second terminal. In this case, it is preferable that the second terminal is connected to the second connection terminal; and the second connection terminal is connected to the power conversion portion via the second switch.

In the above structure in which the power conversion device has the second terminal, it is also possible to employ a structure in which in a case where a second electric wiring for outputting the a.c. power is connected to the second terminal, the second connection terminal is connected to the second terminal via the second electric wiring.

In this case, it is preferable that the photovoltaic generation system according to the first aspect includes the second switch that is able to separate the second connection terminal and the power conversion portion from each other.

In the above structure in which the power conversion device has the second terminal, the second terminal may be structured to double as the second connection terminal.

In the above structure which includes the second connection terminal, preferably, the second connection terminal includes a dedicated connector. According to this structure, it is possible to easily improve safety.

In the above photovoltaic generation system according to the first aspect, preferably, the first connection terminal includes a dedicated connector. According to this structure, it is possible to easily improve the safety. Here, it is more preferable that both of the first connection terminal and the second connection terminal include the dedicated connectors.

In the above photovoltaic generation system according to the first aspect, the alternative power conversion device may be loaded on a transportation means. According to this structure, it is possible to easily dispose the alternative power conversion device near a power conversion device that needs maintenance. Here, as the transportation means, it is possible to use vehicles such as a truck and the like for example.

In the above photovoltaic generation system according to the first aspect, it is preferable that the alternative power conversion device has a function to diagnose a state of the power conversion device.

A power conversion device according to a second aspect of the present invention is a power conversion device that is used for the photovoltaic generation system according to the first aspect.

Besides, a power conversion device according to a third aspect of the present invention includes: the power conversion portion that converts the d.c. power from the solar cell array into the a.c. power; the first terminal that is connected to the electric wiring which connects the collector box which collects the power from the solar cell array; and the first switch that shuts off the output from the solar cell array for the power conversion portion.

In the three aspect, by structuring the power conversion device as described above, it is possible to improve the maintainability.

In the above power conversion device according to the third aspect, preferably, the first connection terminal having the same potential as the electric wiring is further disposed. According to this structure, it is possible to easily improve the maintainability.

In this case, it is preferable that the first terminal is connected to the first connection terminal; and the first connection terminal is connected to the power conversion portion via the first switch.

In the above structure which includes the first connection terminal, it is preferable that the first connection terminal includes the dedicated connector.

In the above power conversion device according to the third aspect, the first terminal may be structured to double as the first connection terminal.

In the above power conversion device according to the third aspect, it is preferable to further include the second terminal as the a.c. output terminal that is connected to the output side of the power conversion portion; and the second connection terminal that has the same potential as the second terminal.

In this case, it is possible to employ a structure in which the second terminal is connected to the power conversion portion via the second connection terminal.

In the above structure which includes the second terminal and the second connection terminal, the second switch which is able to separate the second terminal and the power conversion portion from each other is further disposed; the second terminal may be connected to the second connection terminal; and the second connection terminal may be connected to the power conversion portion via the second switch.

In the above structure which includes the second terminal and the second connection terminal, it is preferable that the second connection terminal includes the dedicated connector.

In the above structure which includes the second terminal and the second connection terminal, the second terminal may be structured to double as the second connection terminal.

A collector box according to a fourth aspect of the present invention is a collector box that is used for the photovoltaic generation system according to the first aspect.

Besides, a collector box according to a fifth aspect of the present invention is a collector box that collects the power from the solar cell array and includes: the first terminal which is connected to the electric wiring that connects to the power conversion device; and the first connection terminal to which the power from the solar cell array is supplied.

In the fifth aspect, by structuring the collector box as described above, it is possible to improve the maintainability of the power conversion device of the photovoltaic generation system.

In the above collector box according to the fifth aspect, preferably, the first switch which shuts off the output from the solar cell array for the power conversion device is further disposed; and the first connection terminal is connected to the first terminal via the first switch. According to this structure, it is possible to easily improve the maintainability.

In the above collector box according to the fifth aspect, it is preferable that the first connection terminal includes the dedicated connector.

In the above collector box according to the fifth aspect, the first terminal may be structured to double as the first connection terminal.

### Advantageous Effects of Invention

As described above, according to the present invention, it is possible to easily obtain a photovoltaic generation system that is excellent in maintainability, a power conversion device and a collection box that are used for the photovoltaic generation system.

### BRIEF DESCRIPTION OF DRAWINGS

FIG. 1 is a block diagram for describing a structure of a photovoltaic generation system according to a first embodiment of the present invention.

FIG. 2 is a block diagram for describing a structure of a power conversion device that is used for the photovoltaic generation system according to the first embodiment of the present invention.

FIG. 3 is a block diagram for describing a structure of a power conversion device that is used for the photovoltaic generation system according to the first embodiment of the present invention.

FIG. 4 is a schematic view for describing a maintenance method (a working procedure during a maintenance time) of a power conversion device of the photovoltaic generation system according to the first embodiment of the present invention.

FIG. 5 is a block diagram for describing a maintenance method (a working procedure during a maintenance time) of a power conversion device of the photovoltaic generation system according to the first embodiment of the present invention.

FIG. 6 is a block diagram for describing a photovoltaic generation system according to a second embodiment of the present invention.

FIG. 7 is a block diagram of a power conversion device that is used for the photovoltaic generation system according to the second embodiment of the present invention.

FIG. 8 is a block diagram of a collector box that is used for the photovoltaic generation system according to the second embodiment of the present invention.

FIG. 9 is a block diagram for describing a maintenance method (a working procedure during a maintenance time) of a power conversion device of the photovoltaic generation system according to the second embodiment of the present invention.

FIG. 10 is a block diagram for describing a photovoltaic generation system according to a third embodiment of the present invention.

FIG. 11 is a block diagram of a power conversion device that is used for the photovoltaic generation system according to the third embodiment of the present invention.

FIG. 12 is a block diagram of a collector box that is used for the photovoltaic generation system according to the third embodiment of the present invention.

FIG. 13 is a block diagram for describing a maintenance method (a working procedure during a maintenance time) of a power conversion device of the photovoltaic generation system according to the third embodiment of the present invention.

FIG. 14 is a block diagram for describing a photovoltaic generation system according to a fourth embodiment of the present invention.

FIG. 15 is a block diagram for describing a maintenance method (a working procedure during a maintenance time) of a power conversion device of the photovoltaic generation system according to the fourth embodiment of the present invention.

FIG. 16 is a block diagram for describing a photovoltaic generation system according to a fifth embodiment of the present invention.

FIG. 17 is a block diagram for describing a maintenance method (a working procedure during a maintenance time) of a power conversion device of the photovoltaic generation system according to the fifth embodiment of the present invention.

FIG. 18 is a block diagram for describing a photovoltaic generation system according to a sixth embodiment of the present invention.

FIG. 19 is a block diagram for describing a maintenance method (a working procedure during a maintenance time) of a power conversion device of the photovoltaic generation system according to the sixth embodiment of the present invention.

FIG. 20 is a block diagram for describing a photovoltaic generation system according to a seventh embodiment of the present invention.

FIG. 21 is a block diagram for describing a photovoltaic generation system according to an eighth embodiment of the present invention.

### DESCRIPTION OF EMBODIMENTS

Hereinafter, embodiments that realize the present invention are described in detail based on the drawings. Here, in the following embodiments, examples of photovoltaic generation systems for a massive photovoltaic generation plant (mega-solar) are described.

### First Embodiment

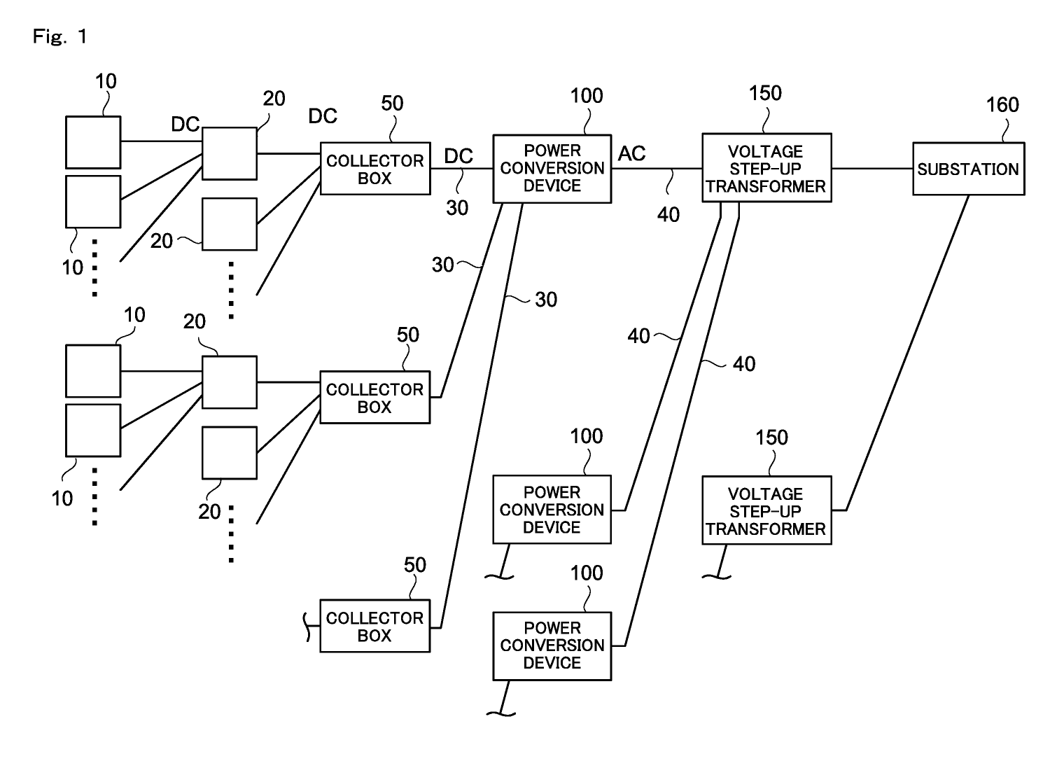

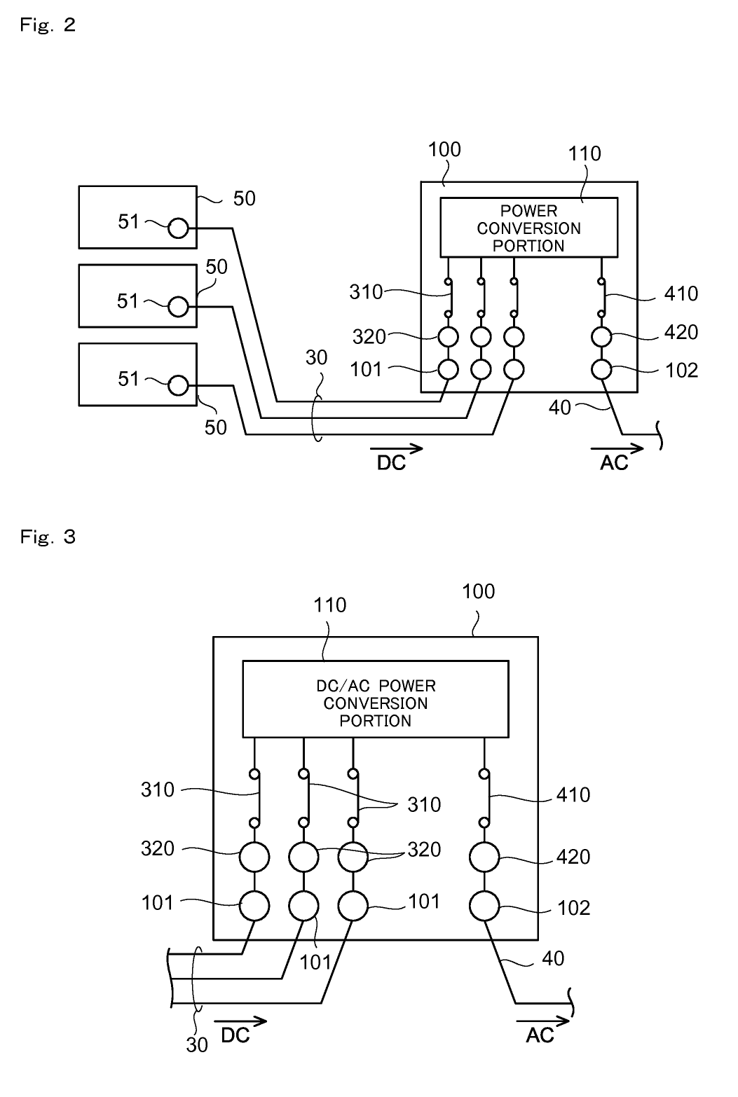

FIG. 1 is a block diagram for describing a structure of a photovoltaic generation system according to a first embodiment of the present invention. FIG. 2 and FIG. 3 are block diagrams for describing a structure of a power conversion device that is used for the photovoltaic generation system according to the first embodiment of the present invention. First, with reference to FIG. 1 to FIG. 3, the photovoltaic generation system according to the first embodiment of the present invention is described.

The photovoltaic generation system according to the first embodiment, as shown in FIG. 1, includes: a plurality of solar cell arrays 10; a connection box 20 that integrates wirings from the solar cell arrays 10 into one; a collector box 50 that integrates wirings from the connection box 20 into one; a power conversion device 100 that converts d.c. power output from the solar cell array 10 into a.c. power and outputs the a.c. power; and a voltage step-up transformer 150 that steps up the voltage of the a.c. power output from the power conversion device 100. Here, the voltage of the a.c. power stepped up by the voltage step-up transformer 150 is sent to a substation 160.

The solar cell array 10 is structured to include a plurality of solar cell modules that are electrically connected to one another. The plurality of solar cell modules are each structured by connecting a plurality of solar cells, which are photoelectric transducing devices, to one another.

The connection box 20 is connected to the plurality of solar cell arrays 10, and has a function to collect output from the solar cell array 10 and to output it to the collector box 50.

The collector box 50 is connected to a plurality of the connection boxes 20, and has a function to collect output from the connection box 20 and to output it to the power conversion device 100. The collector box 50, as shown in FIG. 2, is connected to the power conversion device 100 via a DC cable 30. Besides, the collector box 50 is provided with a connection terminal 51 to which the above DC cable 30 is connected.

As the DC cable 30 that connects the collector box 50 and the power conversion device 100 to each other, a thick cable of about 150 sq is used.

The power conversion device 100 is formed of a power conversion device having a rated output of 250 kW that is used for industry or a photovoltaic generation plant. It is general that 1-to-3 collector boxes are connected to a power conversion device that has the rated output of 250 kW, accordingly, in the first embodiment, the power conversion device 100 is structured to allow three collector boxes 50 to be connected.

Besides, the power conversion device 100, as shown in FIG. 3, is structured to include: a connection terminal 101 to which the above DC cable 30 is connected; a power conversion portion 110 including an inverter that converts the d.c. power from the solar cell array 10 (see FIG. 1) into the a.c. power; and an a.c. output terminal 102 that outputs the a.c. power converted by the power conversion portion 110. Here, the DC cable 30 is an example of a “first electric wiring” and an “electric wiring” of the present invention. Besides, the connection terminals 51 and 101 are an example of a “first terminal” of the present invention, and the a.c. output terminal 102 is an example of a “second terminal” of the present invention.

Besides, as shown in FIG. 2 and FIG. 3, the three collector boxes 50 are connected to the above power conversion device 100 via the DC cables 30. Because of this, the power conversion device 100 is provided with the three connection terminals 101 to which the DC cable 30 is connected. On the other hand, an AC cable 40 is connected to the a.c. output terminal 102 of the power conversion device 100, and the power conversion device 100 and the voltage step-up transformer 150 are connected to each other via the AC cable 40. Here, the AC cable 40 is an example of a “second electric wiring” of the present invention.

Besides, it is usually possible to connect ten or more solar cell arrays 10 to each of the above connection boxes 20, and it is usually possible to connect ten or more connection boxes to each of the above collector boxes 50.

Here, in the first embodiment, the above power conversion device 100 further includes: a switch 310 that shuts off the output from the solar cell array 10 for the power conversion portion 110; a switch 410 that is able to separate the power conversion portion 110 and the a.c. output terminal 102 from each other; connection terminals 320 and 420 for maintenance. Here, the switches 310 and 410 are examples of a “first switch” and a “second switch” of the present invention, respectively, and the connection terminals 320 and 420 for maintenance are examples of a “first connection terminal” and a “second connection terminal” of the present invention, respectively.

The above connection terminal 320 for maintenance and the above switch 310 are each disposed by three to correspond to the connection terminals 101 to which the DC cables 30 are connected, and the above connection terminal 420 for maintenance and the above switch 410 are each disposed by one to correspond to the a.c. output terminal 102.

Besides, the connection terminals 320 for maintenance are each structured to be electrically connected to the connection terminals 101 and to have the same potential as the DC cable 30. Further, the three connection terminals 320 for maintenance are each connected to an input side of the power conversion portion 110 via the above switch 310. On the other hand, the connection terminal 420 for maintenance is electrically connected to the a.c. output terminal 102 and connected to an output side of the power conversion portion 110 via the above switch 410.

The connection terminals 320 and 420 for maintenance of the power conversion device 100 are each connected to an alternative power conversion device described later. Here, it is preferable that the above connection terminals 320 and 420 are each a dedicated connector, and it is more preferable that they have a shape connectable to a dedicated plug only. Besides, it is more preferable that the dedicated connector and dedicated plug are surely insulated and structured such that people cannot touch the terminals directly.

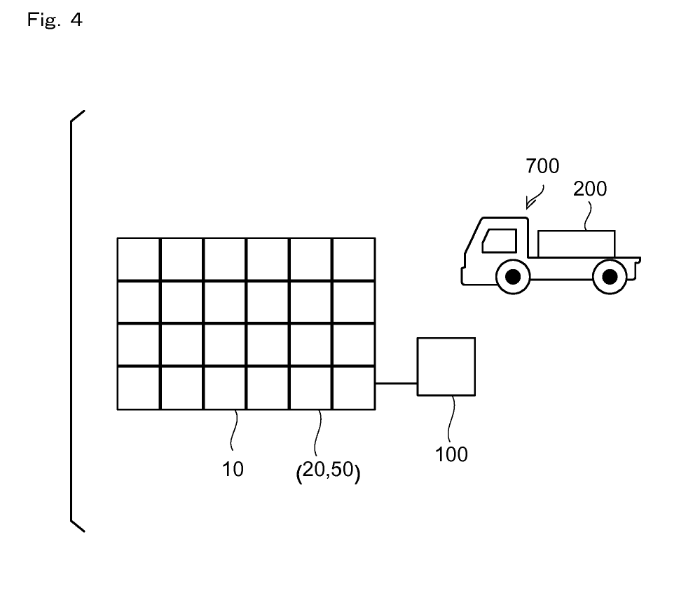

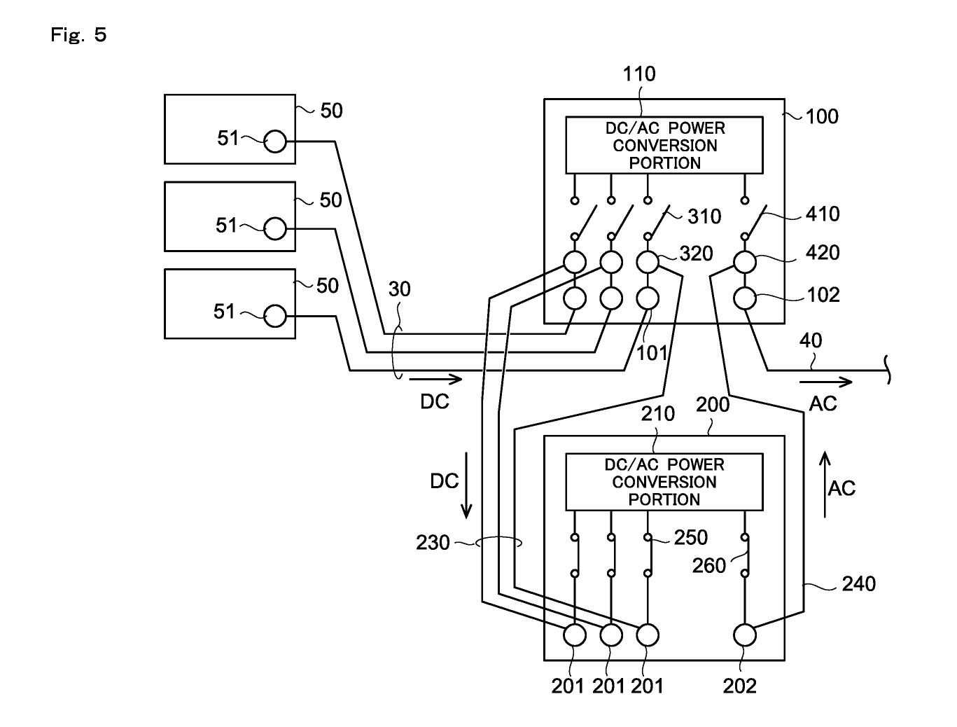

FIG. 4 and FIG. 5 are views for describing a maintenance method (a working procedure during a maintenance time) of the power conversion device of the photovoltaic generation system according to the first embodiment of the present invention. Next, with reference to FIG. 1, FIG. 4 and FIG. 5, a working procedure (trouble recovery method) during a maintenance time of the power conversion device of the photovoltaic generation system according to the first embodiment of the present invention is described.

When it comes to a situation in which maintenance of the power conversion device 100 is necessary, as shown in FIG. 4, an alternative power conversion device 200 having a rated output of 250 kW is loaded onto a 4-ton truck (transportation means) 700 and is transported to a power generation plant (which is near the power conversion device 100 that needs maintenance). Here, as shown in FIG. 5, besides a connection terminal 201 to which a DC cable 230 is connected and an a.c. output terminal 202 to which an AC cable 240 is connected, the alternative power conversion device 200 may be provided with: a switch 250 that shuts off the output from the solar cell array 10 (see FIG. 1) for a power conversion portion 210; and a switch 260 that is able to separate the power conversion portion 110 and the a.c. output terminal 102 from each other.

Next, in the power conversion device 100 that needs the maintenance, by putting the witches 310 and 410 into an opened state, the output from the solar cell array 10 (see FIG. 1) is separated from the power conversion portion 110 in the power conversion device 100.

Next, the DC cable 230 from the alternative power conversion device 200 is connected to the connection terminal 320 for maintenance disposed in the power conversion device 100, while the AC cable 240 from the alternative power conversion device 200 is connected to the connection terminal 420 for maintenance disposed in the power conversion device 100. At this time, as described above, it is preferable that the connection terminal 320 is a dedicated connector that is connectable to only the DC cable 230 from the alternative power conversion device 200, while it is preferable that the connection terminal 420 is a dedicated terminal that is connectable to only the AC cable 240 from the alternative power conversion device 200.

According to this, the power is not supplied to the power conversion device 100 (power conversion portion 110) that needs the maintenance, it becomes possible to perform the maintenance. On the other hand, the alternative power conversion device 200 performs the power conversion that the power conversion device 100 should perform and the power generation is continued. Here, it is preferable that the alternative power conversion device 200 has a function to diagnose a state of the power conversion device 100 (power conversion portion 110).

After completion of the maintenance of the power conversion device 100, the alternative power conversion device 200 is separated. And, by putting the switches 310 and 410 of the power conversion device 100 into a closed state, the power is sent to the power conversion portion 110 in the power conversion device 100, whereby the power conversion is performed.

In the first embodiment, as described above, by disposing the switches 310 and 410 in the power conversion device 100 and by putting the switches 310 and 410 into the opened state, it is possible to shut off the output from the solar cell array 10 for the power conversion portion 110. Besides, by disposing the connection terminals 320 and 420 for maintenance in the power conversion device 100 and by connecting the alternative power conversion device 200 to the connection terminals 320 and 420, it is possible to switch a route of the d.c. power from the solar cell array 10 to the alternative power conversion device 200. According to this, it is possible to perform the maintenance working of the power conversion device 100 (power conversion portion 110) without stopping the power generation at the photovoltaic generation system.

Besides, in the first embodiment, according to the above structure, it is possible to perform the maintenance working without removing the DC cable 30 that connects the collector box 50 and the power conversion device 100 to each other.

### Second Embodiment

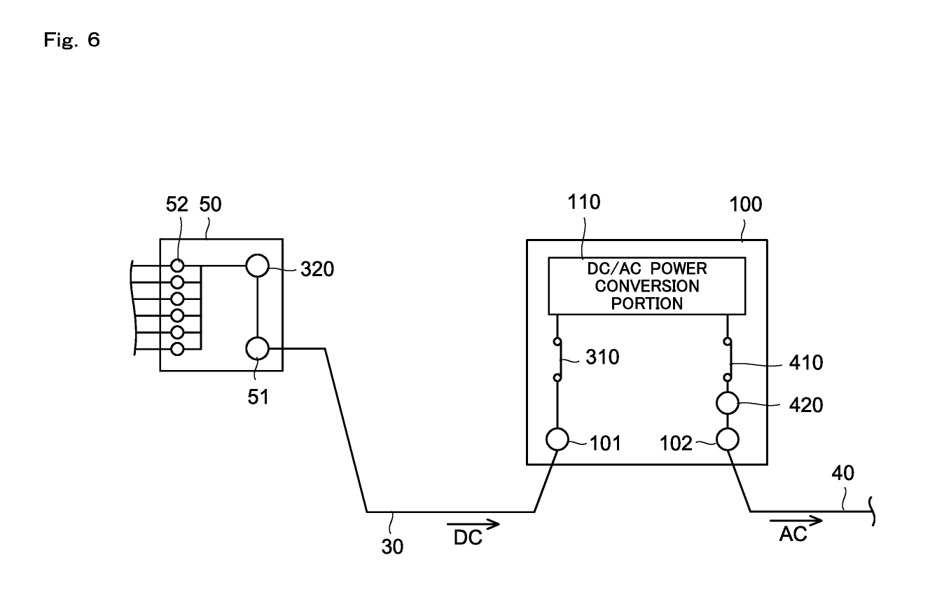

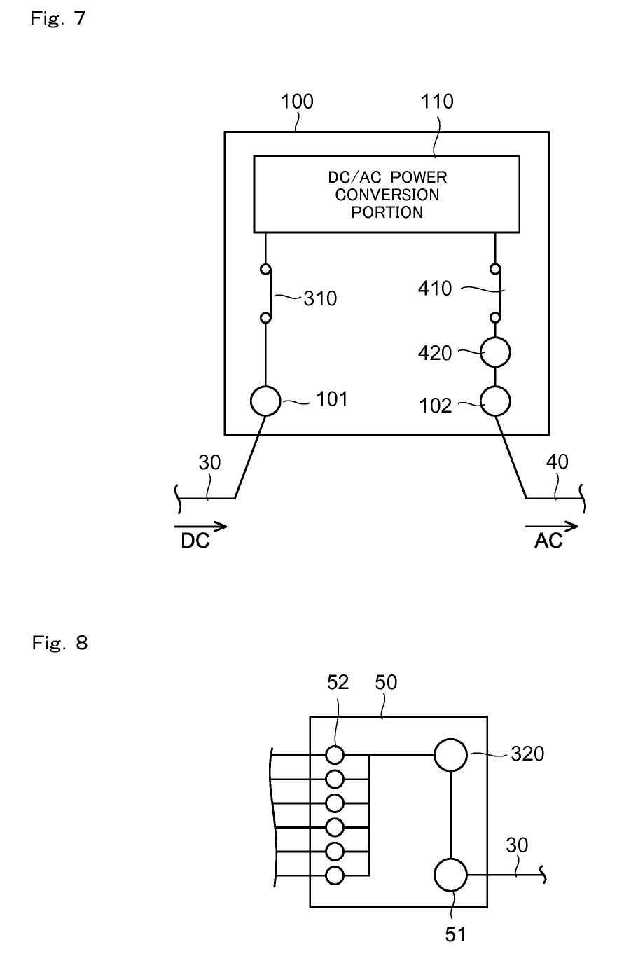

FIG. 6 is a block diagram for describing a photovoltaic generation system according to a second embodiment of the present invention. FIG. 7 is a block diagram of a power conversion device that is used for the photovoltaic generation system according to the second embodiment of the present invention. FIG. 8 is a block diagram of a collector box that is used for the photovoltaic generation system according to the second embodiment of the present invention. Next, with reference to FIG. 6 to FIG. 8, the photovoltaic generation system according to the second embodiment of the present invention is described. Here, in the second embodiment, a case where a power conversion device having a rated output of 100 kW is used is described. Besides, in each figure, corresponding constituent elements are indicated by the same reference numbers, and double description is suitably skipped.

In the second embodiment, as shown in FIG. 6 to FIG. 8, the switch 310, which shuts off the output from the solar cell array for the power conversion portion 110, is disposed in the power conversion device 100, while the connection terminal 320 for maintenance is disposed in the collector box 50. In other words, in the second embodiment, a structure is employed, in which the connection terminal 320 for maintenance is not disposed in the power conversion device 100, but disposed in the collector box 50.

Here, it is general that one collector box is connected to a power conversion device having a rated output of 100 kW, accordingly, in the second embodiment, the power conversion device 100 is structured to allow one collector box 50 to be connected. Because of this, one collector box 50 is connected to the power conversion device 100 via the DC cable 30. Besides, the collector box 50 is provided with one connection terminal 51 to which the above DC cable 30 is connected, while the power conversion device 100 is provided with one connection terminal 101 to which the above DC cable 30 is connected.

Besides, as shown in FIG. 7, in the power conversion device 100, the above connection terminal 101 is connected to the power conversion portion 110 via the switch 310. Further, like in the above first embodiment, the power conversion device 100 according to the second embodiment is structured to include: the a.c. output terminal 102; the switch 410 that is able to separate the power conversion portion 110 and the a.c. output terminal 102 from each other; and the connection terminal 420 for maintenance. Here, the a.c. output terminal 102 is in a state to be electrically connected to the connection terminal 420 for maintenance, and the connection terminal 420 for maintenance is connected to an output side of the power conversion portion 110 via the above switch 410.

On the other hand, the connection terminal 320 for maintenance disposed in the collector box 50, as shown in FIG. 8, is electrically connected to the connection terminal 51; according to this, the connection terminal 320 for maintenance has the same potential as the DC cable 30. Besides, the above collector box 50 is provided with connection terminals 52 for connecting the plurality of connection boxes 20 (see FIG. 1), and the connection terminal 51 and the connection terminals 52 are connected to each other via the connection terminal 320 for maintenance.

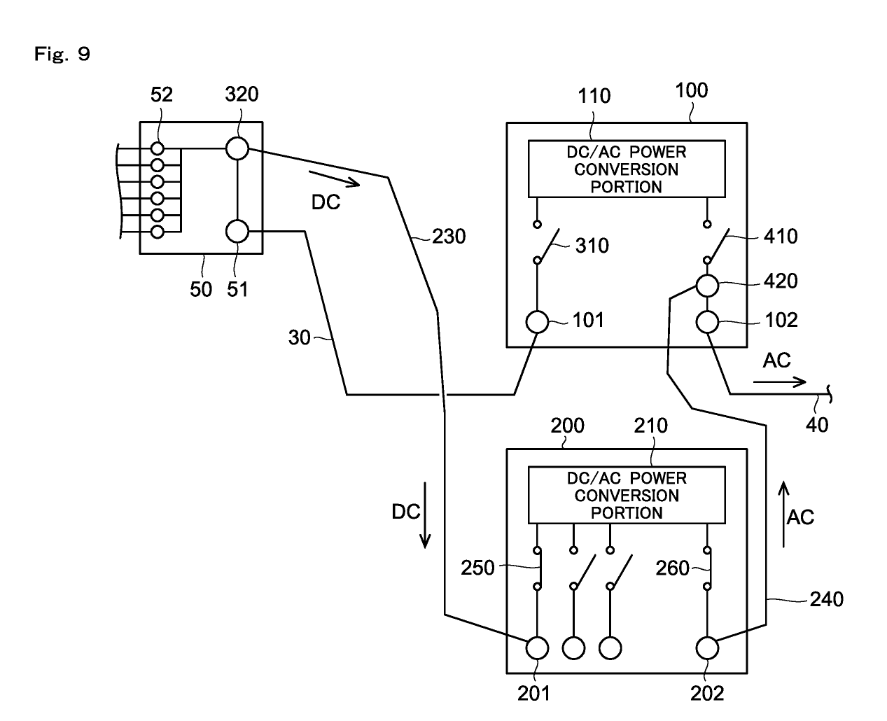

FIG. 9 is a block diagram for describing a maintenance method (a working procedure during a maintenance time) of the power conversion device of the photovoltaic generation system according to the second embodiment of the present invention. Next, with reference to FIG. 4 and FIG. 9, a working procedure during a maintenance time of the power conversion device of the photovoltaic generation system according to the second embodiment of the present invention is described.

When it comes to a situation in which maintenance of the power conversion device 100 is necessary, as shown in FIG. 4, for example, the alternative power conversion device 200 having the rated output of 250 kW is loaded onto the 4-ton truck 700 and is transported to a power generation plant. Here, instead of the above alternative power conversion device 200, an alternative power conversion device having a rated output of 100 kW may be used.

Next, as shown in FIG. 9, in the power conversion device 100 that needs the maintenance, by putting both of the witches 310 and 410 into the opened state, the output form the solar cell array is separated from the power conversion portion 110 in the power conversion device 100.

Next, the DC cable 230 from the alternative power conversion device 200 is connected to the connection terminal 320 for maintenance disposed in the collector box 50, while the AC cable 240 from the alternative power conversion device 200 is connected to the connection terminal 420 for maintenance disposed in the power conversion device 100.

According to this, the power is not supplied to the power conversion device 100 (power conversion portion 110) that needs the maintenance, it becomes possible to perform the maintenance. On the other hand, the alternative power conversion device 200 performs the power conversion that the power conversion device 100 should perform and the power generation is continued.

After completion of the maintenance of the power conversion device 100, the alternative power conversion device 200 is separated. And, by putting the switches 310 and 410 of the power conversion device 100 into the closed state, the power is sent to the power conversion portion 110 in the power conversion device 100, whereby the power conversion is performed.

Here, effects of the second embodiment are the same as the above first embodiment.

### Third Embodiment

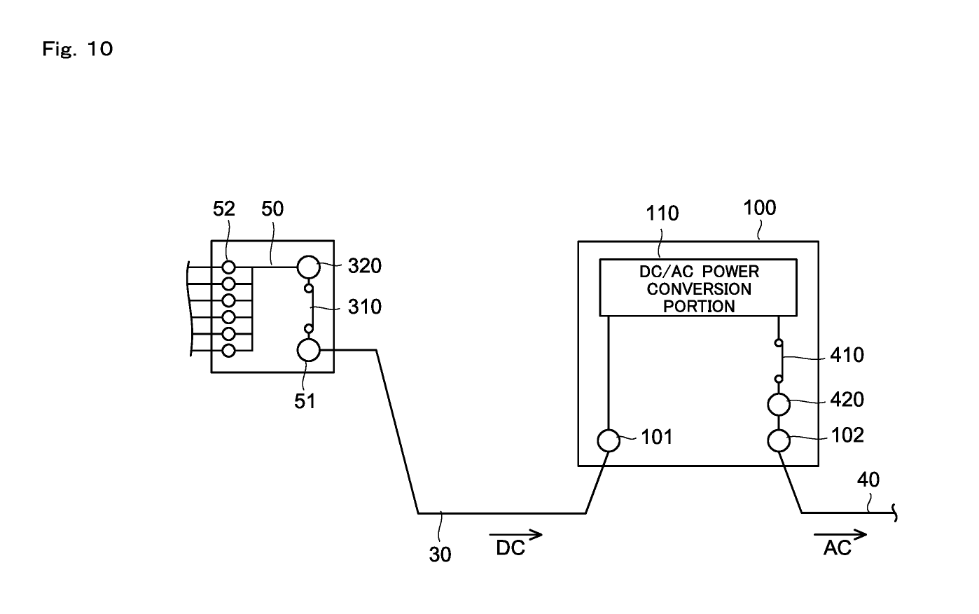

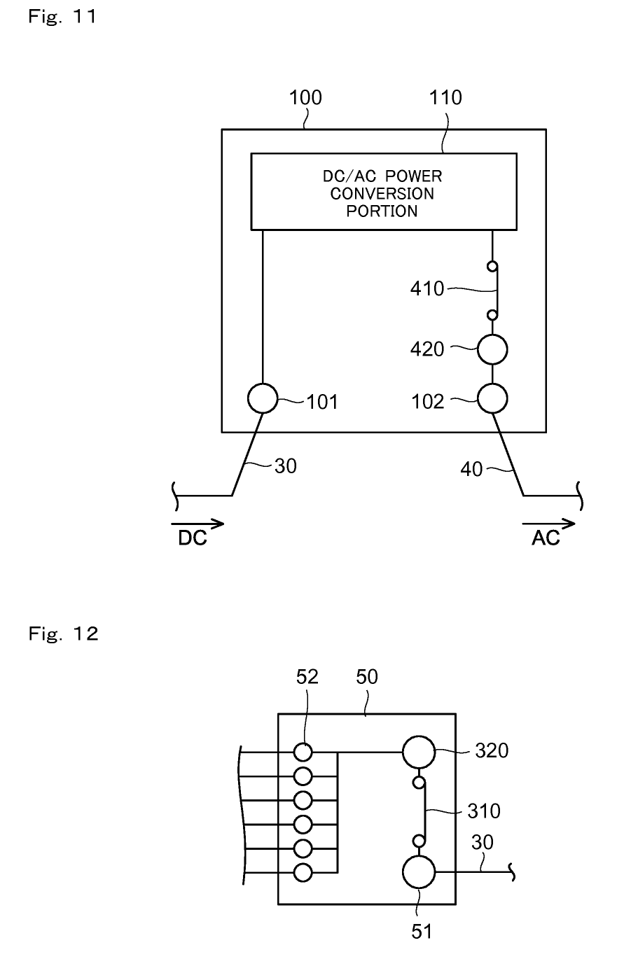

FIG. 10 is a block diagram for describing a photovoltaic generation system according to a third embodiment of the present invention. FIG. 11 is a block diagram of a power conversion device that is used for the photovoltaic generation system according to the third embodiment of the present invention. FIG. 12 is a block diagram of a collector box that is used for the photovoltaic generation system according to the third embodiment of the present invention. Next, with reference to FIG. 10 to FIG. 12, the photovoltaic generation system according to the third embodiment of the present invention is described. Here, in the third embodiment, like in the second embodiment, a case where the power conversion device having the rated output of 100 kW is used is described. Besides, in each figure, corresponding constituent elements are indicated by the same reference numbers, and double description is suitably skipped.

In the third embodiment, as shown in FIG. 10 to FIG. 12, the switch 310, which shuts off the output from the solar cell array for the power conversion portion 110, and the connection terminal 320 for maintenance are disposed in the collector box 50. In other words, in the third embodiment, a structure is employed, in which the connection terminal 320 for maintenance and the above switch 310 are not disposed in the power conversion device 100.

Here, like in the first and second embodiments, the power conversion device 100 according to the third embodiment is structured to include: the a.c. output terminal 102; the switch 410 that is able to separate the power conversion portion 110 and the a.c. output terminal 102 from each other; and the connection terminal 420 for maintenance.

On the other hand, as shown in FIG. 12, in the above collector box 50, the switch 310 is disposed between the connection terminal 320 for maintenance and the connection terminal 51 to which the DC cable 30 is connected. In other words, the connection terminal 320 for maintenance is connected to the connection terminal 51, to which the DC cable 30 is connected, via the switch 310.

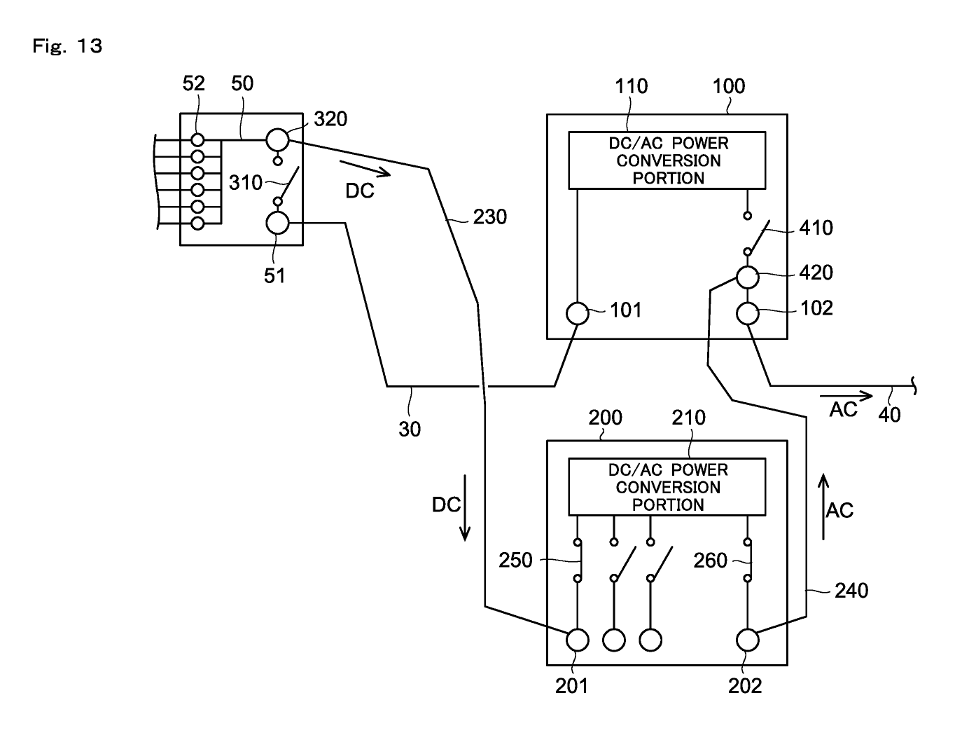

FIG. 13 is a block diagram for describing a maintenance method (a working procedure during a maintenance time) of the power conversion device of the photovoltaic generation system according to the third embodiment of the present invention. Next, with reference to FIG. 4 and FIG. 13, a working procedure during a maintenance time of the power conversion device of the photovoltaic generation system according to the third embodiment of the present invention is described.

When it comes to a situation in which maintenance of the power conversion device 100 is necessary, as shown in FIG. 4, the alternative power conversion device 200 having the rated output of 250 kW is loaded onto the 4-ton truck 700 and is transported to a power generation plant. Here, instead of the above alternative power conversion device 200, the alternative power conversion device having the rated output of 100 kW may be used.

Next, as shown in FIG. 13, by putting the witch 310 of the collector box 50 into the opened state and putting the switch 410 of the power conversion device 100 that needs the maintenance into the opened state, the output from the solar cell array is separated from the power conversion portion 110 in the power conversion device 100.

Next, the DC cable 230 from the alternative power conversion device 200 is connected to the connection terminal 320 for maintenance disposed in the collector box 50, while the AC cable 240 from the alternative power conversion device 200 is connected to the connection terminal 420 for maintenance disposed in the power conversion device 100.

According to this, the power is not supplied to the power conversion device 100 (power conversion portion 110) that needs the maintenance, it becomes possible to perform the maintenance. On the other hand, the alternative power conversion device 200 performs the power conversion that the power conversion device 100 should perform and the power generation is continued.

After completion of the maintenance of the power conversion device 100, the alternative power conversion device 200 is separated. And, by putting both of the switches 310 of the collector box 50 and the switch 410 of the power conversion device 100 into the closed state, the power is sent to the power conversion portion 110 in the power conversion device 100, whereby the power conversion is performed.

Here, effects of the third embodiment are the same as the above first embodiment.

### Fourth Embodiment

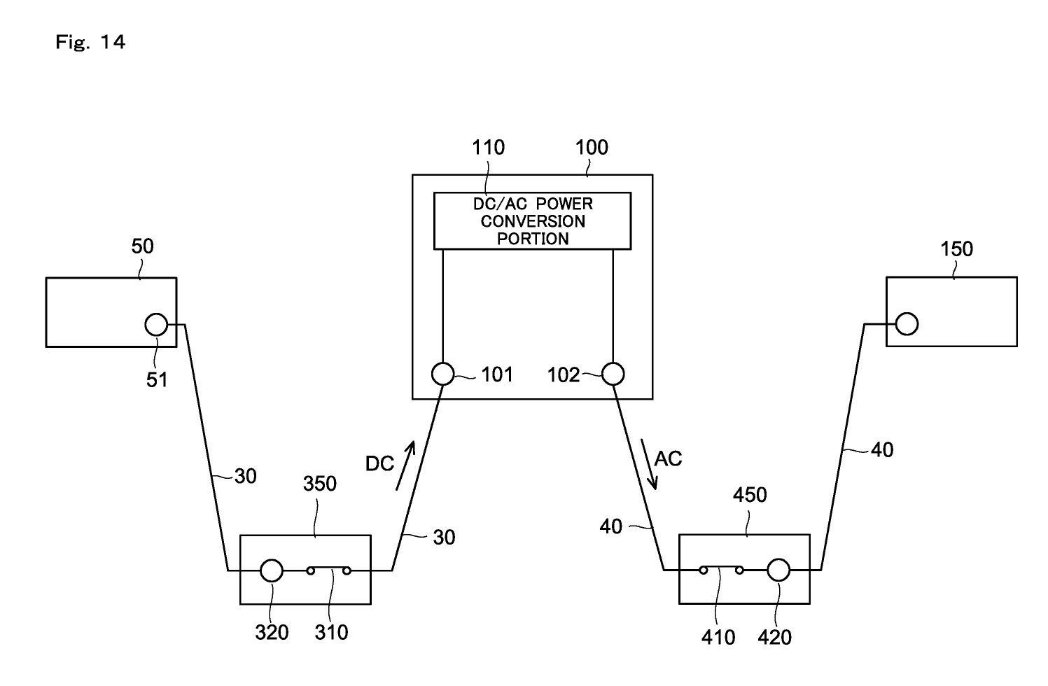

FIG. 14 is a block diagram for describing a photovoltaic generation system according to a fourth embodiment of the present invention. Next, with reference to FIG. 14, the photovoltaic generation system according to the fourth embodiment of the present invention is described. Here, in the fourth embodiment, like in the second and third embodiments, a case where the power conversion device having the rated output of 100 kW is used is described. Besides, in each figure, corresponding constituent elements are indicated by the same reference numbers, and double description is suitably skipped.

In the fourth embodiment, as shown in FIG. 14, a first terminal box 350 including the connection terminal 320 for maintenance is connected between the collector box 50 and the power conversion device 100. The first terminal box 350 is provided with, as well as the above connection terminal 320, the switch 310 that shuts off the output from the solar cell array for the power conversion portion 110. Besides, in the above first terminal box 350, the connection terminal 320 for maintenance is connected to the power conversion portion 110 of the power conversion device 100 via the switch 310.

Besides, in the fourth embodiment, also, a connection box (second terminal box 450) similar to the above first terminal box 350 is connected between the power conversion device 100 and the voltage step-up transformer 150. The second terminal box 450 is provided with the connection terminal 420 for maintenance and the switch 410. Besides, in the above second terminal box 450, the connection terminal 420 for maintenance is connected to the power conversion portion 110 of the power conversion device 100 via the switch 410.

Here, in the fourth embodiment, a structure is employed, in which the connection terminal for maintenance and the switch are not disposed in any of the power conversion device 100 and the collector box 50.

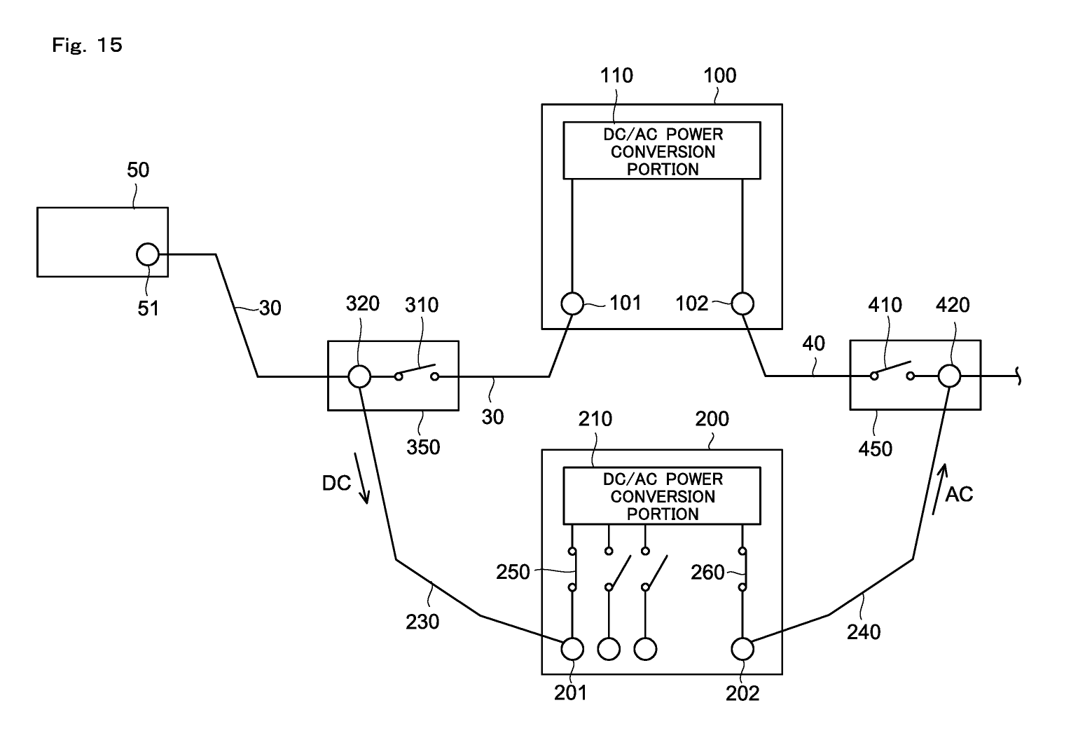

FIG. 15 is a block diagram for describing a maintenance method (a working procedure during a maintenance time) of the power conversion device of the photovoltaic generation system according to the fourth embodiment of the present invention. Next, with reference to FIG. 4 and FIG. 15, a working procedure during a maintenance time of the power conversion device of the photovoltaic generation system according to the fourth embodiment of the present invention is described.

When it comes to a situation in which maintenance of the power conversion device 100 is necessary, as shown in FIG. 4, the alternative power conversion device 200 having the rated output of 250 kW is loaded onto the 4-ton truck 700 and is transported to a power generation plant. Here, instead of the above alternative power conversion device 200, the alternative power conversion device having the rated output of 100 kW may be used.

Next, as shown in FIG. 15, by putting both of the switch 310 of the first terminal box 350 and the switch 410 of the second terminal box 450 into the opened state, the output from the solar cell array is separated from the power conversion portion 110 in the power conversion device 100.

Next, the DC cable 230 from the alternative power conversion device 200 is connected to the connection terminal 320 for maintenance disposed in the first terminal box 350, while the AC cable 240 from the alternative power conversion device 200 is connected to the connection terminal 420 for maintenance disposed in the second terminal box 450.

According to this, the power is not supplied to the power conversion device 100 (power conversion portion 110) that needs the maintenance, it becomes possible to perform the maintenance. On the other hand, the alternative power conversion device 200 performs the power conversion that the power conversion device 100 should perform and the power generation is continued.

After completion of the maintenance of the power conversion device 100, the alternative power conversion device 200 is separated. And, by putting both of the switch 310 of the first terminal box 350 and the switch 410 of the second terminal box 450 into the closed state, the power is sent to the power conversion portion 110 in the power conversion device 100, whereby the power conversion is performed.

Here, effects of the fourth embodiment are the same as the above first embodiment.

### Fifth Embodiment

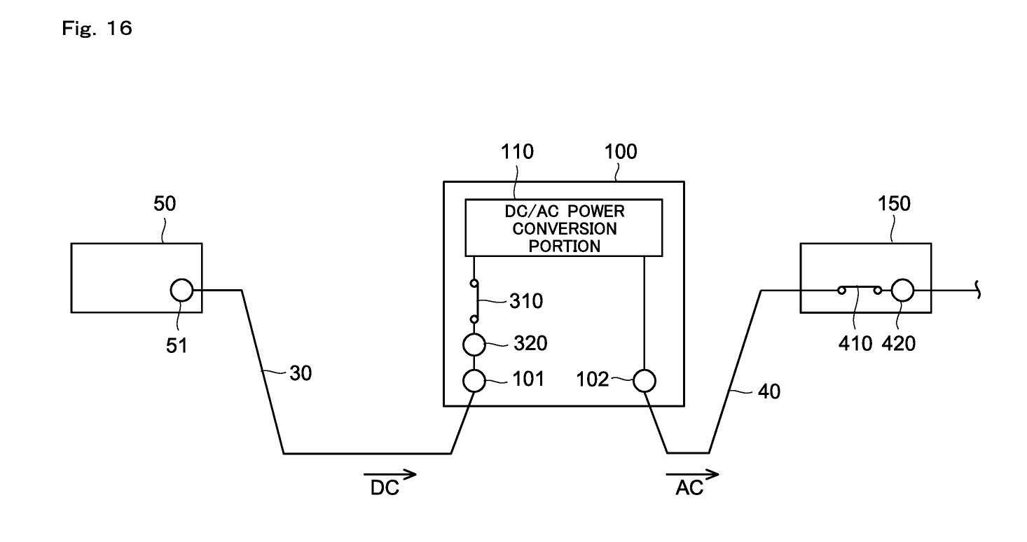

FIG. 16 is a block diagram for describing a photovoltaic generation system according to a fifth embodiment of the present invention. Next, with reference to FIG. 16, the photovoltaic generation system according to the fifth embodiment of the present invention is described. Here, in the fifth embodiment, like in the second to fourth embodiments, a case where the power conversion device having the rated output of 100 kW is used is described. Besides, in each figure, corresponding constituent elements are indicated by the same reference numbers, and double description is suitably skipped.

In the photovoltaic generation system according to the fifth embodiment, as shown in FIG. 16, in the voltage step-up transformer 150 that steps up the voltage of the a.c. power output from the power conversion device 100, the connection terminal 420 for maintenance and the switch 410 are disposed. Besides, to make it possible to separate the power conversion portion 110 and the connection terminal 420 for maintenance from each other, the above switch 410 is disposed between the power conversion portion 110 and the connection terminal 420 for maintenance.

Here, in the fifth embodiment, in the voltage step-up transformer 150 that is connected to the output side of the power conversion device 100, the switch 410 and the connection terminal 420 for maintenance are disposed, accordingly, unlike the above first to third embodiments, a structure is employed, in which the switch and the connection terminal for maintenance are not disposed between the power conversion portion 110 of the power conversion device 100 and the a.c. output terminal 102.

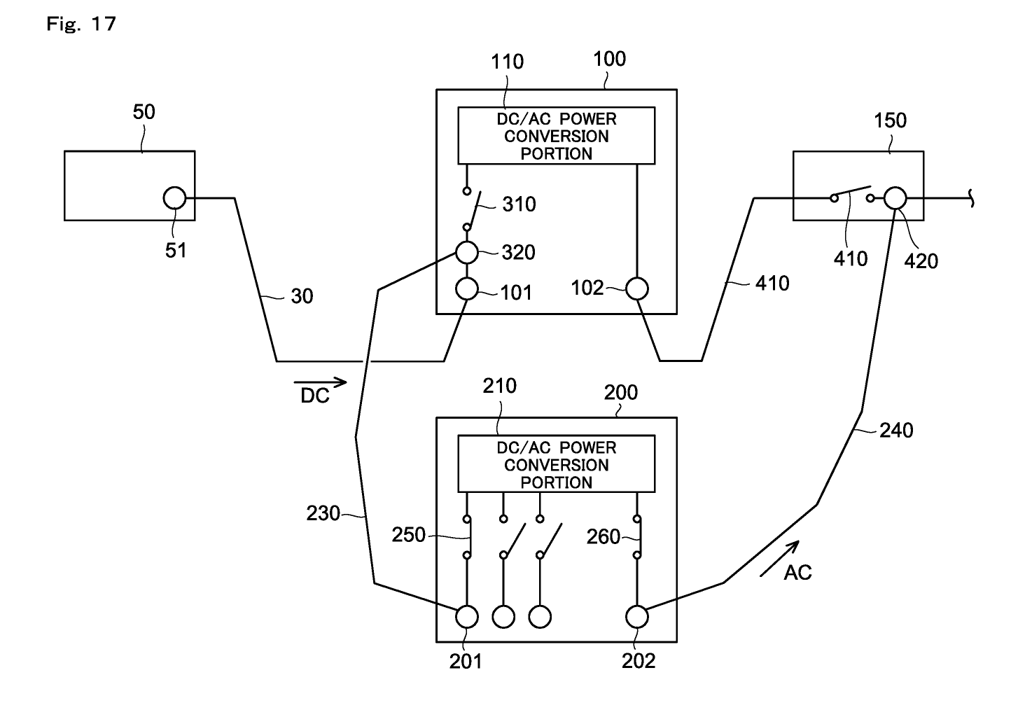

FIG. 17 is a block diagram for describing a maintenance method (a working procedure during a maintenance time) of the power conversion device of the photovoltaic generation system according to the fifth embodiment of the present invention. Next, with reference to FIG. 4 and FIG. 17, a working procedure during a maintenance time of the power conversion device of the photovoltaic generation system according to the fifth embodiment of the present invention is described.

When it comes to a situation in which maintenance of the power conversion device 100 is necessary, as shown in FIG. 4, for example, the alternative power conversion device 200 having the rated output of 250 kW is loaded onto the 4-ton truck 700 and is transported to a power generation plant. Here, instead of the above alternative power conversion device 200, the alternative power conversion device having the rated output of 100 kW may be used.

Next, as shown in FIG. 17, by putting the switch 310 of the power conversion device 100 that needs the maintenance into the opened state and putting the switch 410 of the voltage step-up transformer 150 into the opened state, the output from the solar cell array is separated from the power conversion portion 110 in the power conversion device 100.

Next, the DC cable 230 from the alternative power conversion device 200 is connected to the connection terminal 320 for maintenance disposed in the power conversion device 100, while the AC cable 240 from the alternative power conversion device 200 is connected to the connection terminal 420 for maintenance disposed in the voltage step-up transformer 150.

According to this, the power is not supplied to the power conversion device 100 (power conversion portion 110) that needs the maintenance, it becomes possible to perform the maintenance. On the other hand, the alternative power conversion device 200 performs the power conversion that the power conversion device 100 should perform and the power generation is continued.

After completion of the maintenance of the power conversion device 100, the alternative power conversion device 200 is separated. And, by putting both of the switch 310 of the power conversion device 100 and the switch 410 of the voltage step-up transformer 150 into the closed state, the power is sent to the power conversion portion 110 in the power conversion device 100, whereby the power conversion is performed.

Here, effects of the fifth embodiment are the same as the above first embodiment.

### Sixth Embodiment

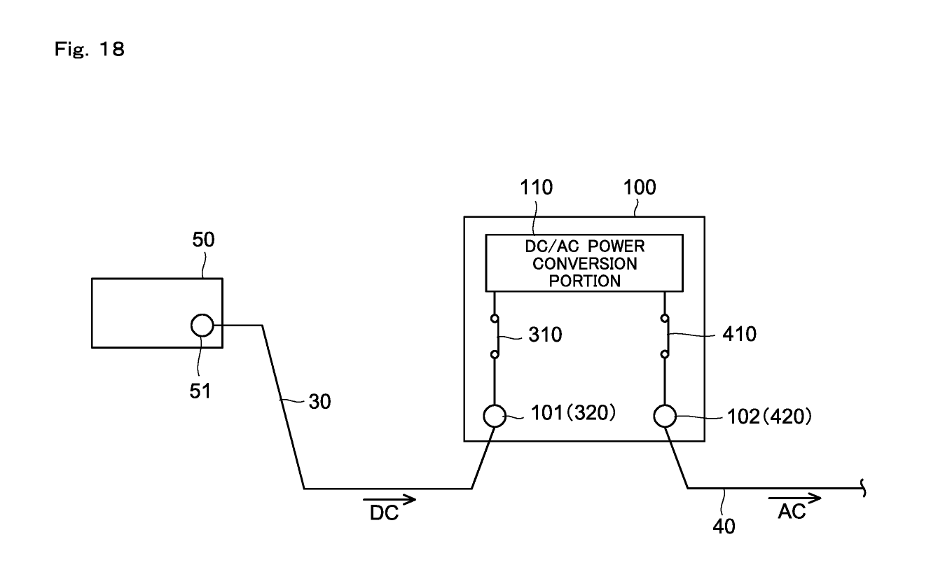

FIG. 18 is a block diagram for describing a photovoltaic generation system according to a sixth embodiment of the present invention. Next, with reference to FIG. 18, the photovoltaic generation system according to the sixth embodiment of the present invention is described. Here, in the sixth embodiment, like in the second to fifth embodiments, a case where the power conversion device having the rated output of 100 kW is used is described. Besides, in each figure, corresponding constituent elements are indicated by the same reference numbers, and double description is suitably skipped.

In the sixth embodiment, as shown in FIG. 18, in the power conversion device 100, the connection terminal 101 to which the DC cable 30 is connected and the connection terminal (a.c. output terminal 102) to which the AC cable 40 is connected double as the connection terminals 320 and 420 for maintenance, respectively.

Besides, the above power conversion device 100 is provided with the switch 310 that shuts off the output from the solar cell array for the power conversion portion 110 and with the switch 410 that is able to separate the power conversion portion 110 and the a.c. output terminal 102 from each other. According to this, by putting the above switches 310 and 410 into the opened state, the output from the solar cell array becomes separable from the power conversion portion 110 in the power conversion device 100.

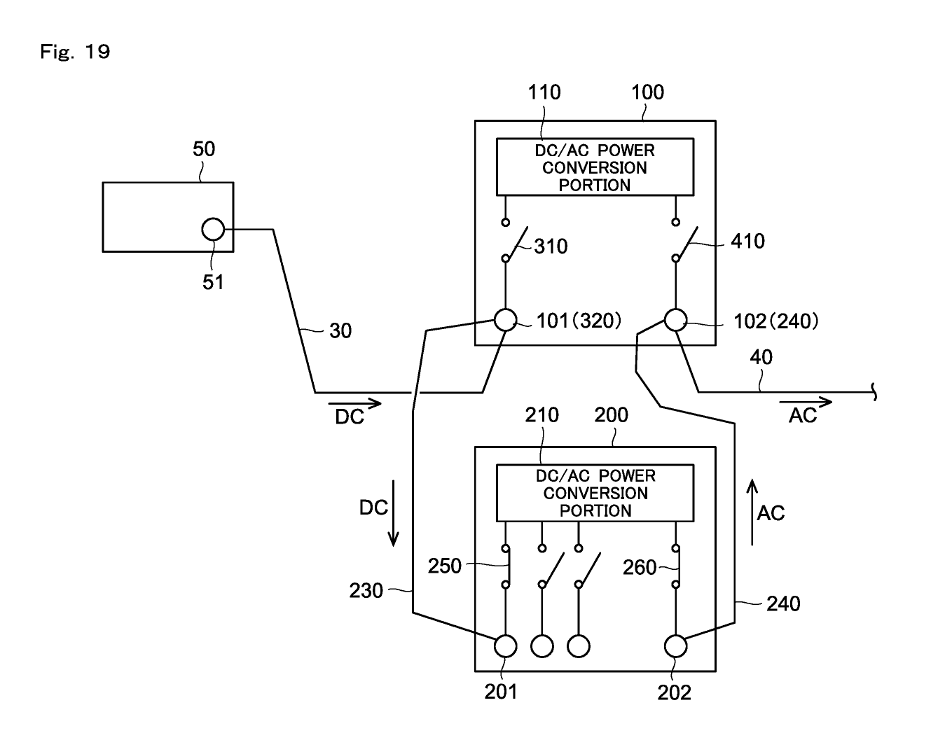

FIG. 19 is a block diagram for describing a maintenance method (a working procedure during a maintenance time) of the power conversion device of the photovoltaic generation system according to the sixth embodiment of the present invention. Next, with reference to FIG. 4 and FIG. 19, a working procedure during a maintenance time of the power conversion device of the photovoltaic generation system according to the sixth embodiment of the present invention is described.

When it comes to a situation in which maintenance of the power conversion device 100 is necessary, as shown in FIG. 4, for example, the alternative power conversion device 200 having the rated output of 250 kW is loaded onto the 4-ton truck 700 and is transported to a power generation plant. Here, instead of the above alternative power conversion device 200, the alternative power conversion device having the rated output of 100 kW may be used.

Next, as shown in FIG. 19, by putting the witches 310 and 410 of the power conversion device 100 that needs the maintenance into the opened state, the output from the solar cell array is separated from the power conversion portion 110 in the power conversion device 100.

Next, the DC cable 230 from the alternative power conversion device 200 is connected to the connection terminal 101 (320) disposed in the power conversion device 100, while the AC cable 240 from the alternative power conversion device 200 is connected to the a.c. output terminal 102 (420) disposed in the power conversion device 100.

According to this, the power is not supplied to the power conversion device 100 (power conversion portion 110) that needs the maintenance, it becomes possible to perform the maintenance. On the other hand, the alternative power conversion device 200 performs the power conversion that the power conversion device 100 should perform and the power generation is continued.

After completion of the maintenance of the power conversion device 100, the alternative power conversion device 200 is separated. And, by putting both of the switches 310 and 410 of the power conversion device 100 into the closed state, the power is sent to the power conversion portion 110 in the power conversion device 100, whereby the power conversion is performed.

Here, effects of the sixth embodiment are the same as the above first embodiment.

### Seventh Embodiment

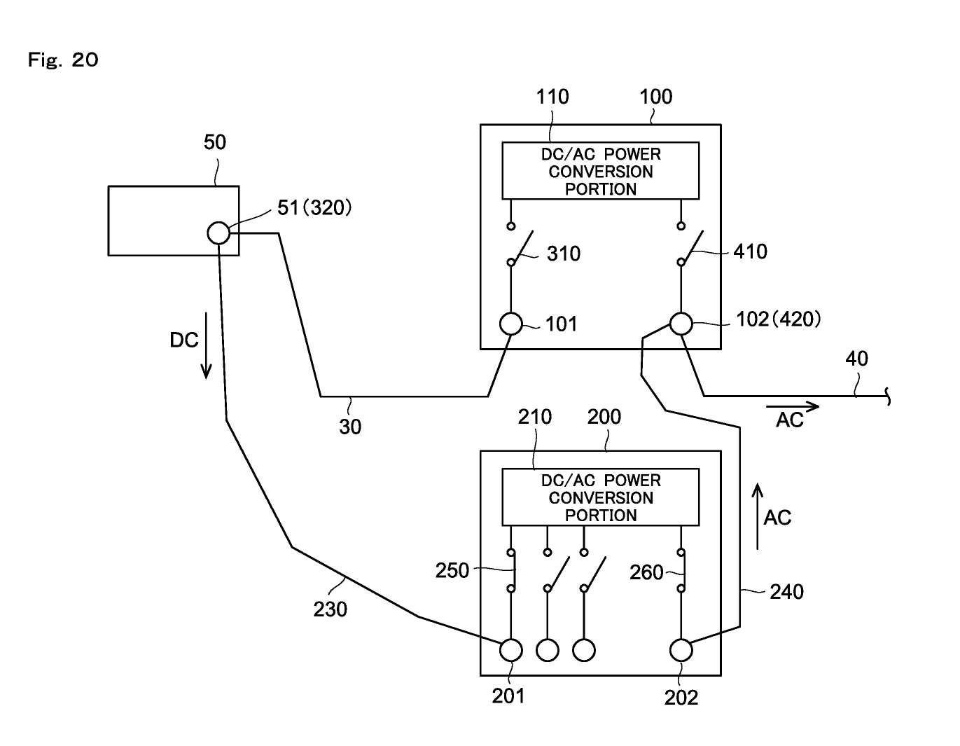

FIG. 20 is a block diagram for describing a photovoltaic generation system according to a seventh embodiment of the present invention. Next, with reference to FIG. 20, the photovoltaic generation system according to the seventh embodiment of the present invention is described. Here, in the seventh embodiment, like in the second to sixth embodiments, a case where the power conversion device having the rated output of 100 kW is used is described. Besides, in each figure, corresponding constituent elements are indicated by the same reference numbers, and double description is suitably skipped.

In the seventh embodiment, as shown in FIG. 20, the connection terminal 51 of the collector box 50 in the above sixth embodiment doubles as the connection terminal 320 for maintenance. Because of this, during the maintenance time of the power conversion device 100, the DC cable 230 from the alternative power conversion device 200 is connected to the connection terminal 51 (320) of the collector box 50.

Here, effects of the seventh embodiment are the same as the above first and sixth embodiments.

### Eighth Embodiment

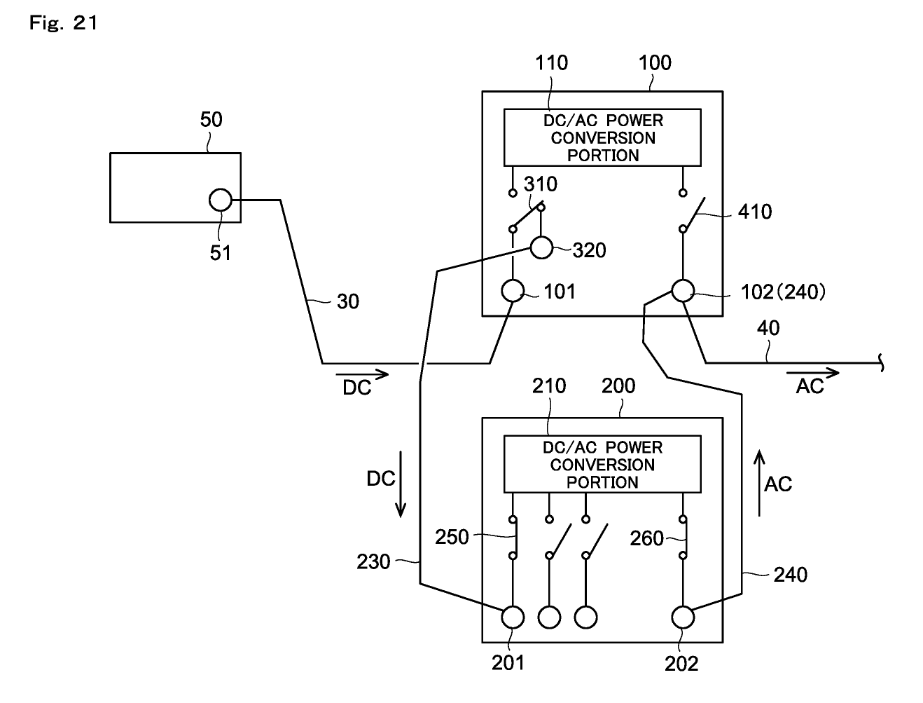

FIG. 21 is a block diagram for describing a photovoltaic generation system according to an eighth embodiment of the present invention. Next, with reference to FIG. 21, the photovoltaic generation system according to the eighth embodiment of the present invention is described. Here, in the eighth embodiment, like in the second to seventh embodiments, a case where the power conversion device having the rated output of 100 kW is used is described. Besides, in each figure, corresponding constituent elements are indicated by the same reference numbers, and double description is suitably skipped.

In the eighth embodiment, as shown in FIG. 21, the power conversion device 100 in the structure of the above sixth embodiment is provided with the connection terminal 320 for maintenance. Besides, in the eighth embodiment, unlike the above first to seventh embodiments, the switch 310 is formed of a changeover switch. The changeover switch 310 has a function to switch a connection destination of the connection terminal 101, to which the DC cable 30 is connected, to the power conversion portion 110 or the connection terminal 320 for maintenance. Because of this, the supply destination of the d.c. power from the solar cell array is switched to the power conversion portion 100 or the connection terminal 320 for maintenance.

Specifically, in a case where the changeover switch 310 is connected to the power conversion portion 110, the power from the solar cell array is supplied to the power conversion portion 110 and is not supplied to the connection terminal 320 for maintenance. And, when the connection of the changeover switch 310 is switched to the connection terminal 320 for maintenance, the output from the solar cell array for the power conversion portion 110 is shut off, and the d.c. power from the solar cell array is supplied to the connection terminal 320 for maintenance.

Accordingly, in the state in which the changeover switch 310 is connected to the power conversion portion 110, when connecting the DC cable 230 from the alternative power conversion device 200 to the connection terminal 320 for maintenance, the power from the solar cell array is not supplied to the connection terminal 320 for maintenance, accordingly, it is possible to safely connect the DC cable 230. And, after connection of the DC cable 230, if the changeover switch 310 is switched to the connection terminal 320 for maintenance, the output from the solar cell array for the power conversion portion 110 is shut off, and the d.c. power from the solar cell array is supplied to the alternative power conversion device 200. According to this, it is possible to make the alternative power conversion device 200 perform the power conversion that the power conversion device 100 should perform.

It should be considered that the embodiments disclosed this time are examples in all respects and are not limiting. The scope of the present invention is not indicated by the above description of the embodiments but by the claims, and all modifications within the scope of the claims and the meaning equivalent to the claims are covered.

For example, in the above first to eighth embodiments, the example is described, in which the present invention is applied to the photovoltaic generation system for a photovoltaic generation plant; however, the present invention is not limited to this, and the present invention is also applicable to a photovoltaic generation system for industry and a photovoltaic generation system for home use other than the photovoltaic generation plant.

Besides, in the above first to eighth embodiments, the structural example is described, in which the alternative power conversion device is loaded onto the 4-ton truck and transported near the power conversion device that needs the maintenance; however, the present invention is not limited to this, and as the transportation means on which the alternative power conversion device is loaded, a truck vehicle other than the 4-ton truck may be used. Besides, a transportation means other than the truck vehicle may be used. For example, a structure may be employed, in which the alternative power conversion device is loaded onto a cart; and the cart is led by a motorcycle.

Besides, in the above first to eighth embodiments, considering safety of the system, in a case where a breaker is disposed in the system, the connection terminal for maintenance may be disposed to make the breaker disposed in advance play a role of the switch. According to this, it is possible to reduce additional members.

Further, in the above first to eighth embodiments, a structure may be employed, in which the switch (second switch) is not disposed on the output side of the power conversion portion of the power conversion device.

Here, it is also possible to suitably combine the structures of the above first to eighth embodiments.

Besides, in the above first embodiment, the example is described, in which the power conversion device having the rated output of 250 kW is used in the photovoltaic generation system; however, the present invention is not limited to this, and the power conversion device used in the photovoltaic generation system may be a power conversion device (e.g., the power conversion device having the rated output of 100 kW) that has a rated output other than 250 kW.

Besides, in the above second to eighth embodiments, the example is described, in which the power conversion device having the rated output of 100 kW is used in the photovoltaic generation system; however, the present invention is not limited to this, and the power conversion device used in the photovoltaic generation system may be a power conversion device (e.g., the power conversion device having the rated output of 250 kW) that has a rated output other than 100 kW.

Here, in a photovoltaic generation plant, as a disposition method of the solar cell array (solar cell module) and the power conversion device, there are a dispersion method and a central method, and in both methods, the power conversion device is disposed near the solar cell array. This is because the power generated by the solar cell module is d.c. power, accordingly, it is preferable that the distance between the solar cell array and the power conversion device is short. On the other hand, if the capacity of the power conversion device is made large, the outer size also becomes invariably large, and a shadow of the power conversion device influences the solar cell array. Because of this, the capacity of the power conversion device does not become large so much, and 100 kW to about 1 MW are used. Besides, generally, there are many cases where a breaker, that is, a safety component used in a power conversion device, is in a class of 200 A to 400 A, accordingly, for the power conversion device, the rated outputs of 100 kW and 250 kW are widespread for industry. Because of this, as the power conversion device for industry and for a photovoltaic generation plant, the rated outputs of 100 kW and 250 kW are generally used; however, even in a case where a power conversion device other than these, it is possible to effectively apply the present invention. In this case, in accordance with a power conversion device that needs maintenance, it is possible to suitably select an alternative power conversion device.

Besides, in the above fourth embodiment, the example is described, in which the terminal box is disposed in both spaces between the collector box and the power conversion device and between the power conversion device and the voltage step-up transformer; however, the present invention is not limited to this, and a structure may be employed, in which the terminal box is disposed in either of the spaces between the collector box and the power conversion device and between the power conversion device and the voltage step-up transformer.

Besides, in the above fourth embodiment, the example is described, in which together with the connection terminal for maintenance, the switch is disposed in the terminal box; however, the present invention is not limited to this, and a structure may be employed, in which the switch is not disposed in the terminal box.

Besides, in the above fifth embodiment, the example is described, in which the connection terminal for maintenance is disposed in the voltage step-up transformer; however, the present invention is not limited to this, and a connection terminal originally disposed in the voltage step-up transformer may double as the connection terminal for maintenance.

Besides, in the above fifth embodiment, the example is described, in which together with the connection terminal for maintenance, the switch is disposed in the voltage step-up transformer; however, the present invention is not limited to this, and a structure may be employed, in which the switch is not disposed in the voltage step-up transformer.

Besides, in the above eighth embodiment, the example is described, in which the switch formed of the changeover switch is disposed in the power conversion device; however, the present invention is not limited to this, and the above changeover switch may be disposed at a place other than the power conversion device. For example, the changeover switch may be disposed in the collector box or in a case where the above terminal box (first terminal box) is disposed between the power conversion device and the collector box, the changeover switch may be disposed in the terminal box.

Here, in the above eighth embodiment, the structure is employed, in which the connection terminal (a.c. output terminal) to which the AC cable is connected doubles as the connection terminal for maintenance; however, of course, it is possible to dispose the a.c. output terminal and the connection terminal for maintenance independent of each other. In this case, the switch (second switch), which is able to separate the power conversion device and the a.c. output terminal from each other, is usable as the same changeover switch as described above. In other words, not only the switch (first switch) on the input side of the power conversion device but also the switch (second switch) on the output side of the power conversion device are usable as the same changeover switch.

### REFERENCE SIGNS LIST

10 solar cell array
20 connection box
30 DC cable (first electric wiring, electric wiring)
40 AC cable (second electric wiring)
50 collector box
51 connection terminal (first terminal)
100 power conversion device
101 connection terminal (first terminal)
102 a.c. output terminal (second terminal)
110 power conversion portion
150 voltage step-up transformer
160 substation
200 alternative power conversion device
201 connection terminal
202 a.c. output terminal
310 switch (first switch, changeover switch)
320 connection terminal (first connection terminal)
350 first terminal box
410 switch (second switch)
420 connection terminal (second connection terminal)
450 second terminal box
700 4-ton truck (transportation means)

1. A photovoltaic generation system comprising:
a solar cell array that includes a plurality of solar cell modules;
a collector portion that collects power from the solar cell array;
a power control portion that is connected to the collector portion and includes a power conversion portion which converts first power from the solar cell array into second power;
a first electric wiring that connects the collector portion and the power control portion to each other;
a first connection terminal that is supplied with the first power from the solar cell array; and
a first switch portion that shuts off output from the solar cell array for the power conversion portion; wherein
an alternative power control portion is connectable to the first connection terminal.

2. The photovoltaic generation system according to claim 1, wherein
the collector portion and the power control portion both include a first terminal to which the first electric wiring is connected; and
the first connection terminal and the first switch portion are both disposed in at least one of the collector portion and the power control portion.

3. The photovoltaic generation system according to claim 2, wherein
the power control portion includes the first connection terminal, the first terminal and the first switch portion.

4. The photovoltaic generation system according to claim 3, wherein
the first terminal of the power control portion is connected to the first connection terminal; and
the first connection terminal is connected to the power conversion portion via the first switch portion.

5. The photovoltaic generation system according to claim 1, wherein
the collector portion and the power control portion both include a first terminal to which the first electric wiring is connected; and
the first terminal doubles as the first connection terminal.

6. The photovoltaic generation system according to claim wherein
the collector portion includes the first connection terminal; and
the power control portion includes the first switch portion that shuts off the output from the solar cell array for the power conversion portion.

7. The photovoltaic generation system according to claim 1, wherein
the collector portion includes a first terminal to which the first electric wiring is connected, the first connection terminal and the first switch portion; and
the first connection terminal is connected to the first terminal via the first switch portion.

8. The photovoltaic generation system according to claim 1, wherein
the first connection terminal is disposed between the collector portion and the power control portion and connected to the power conversion portion via the first switch portion.

9. The photovoltaic generation system according to claim 1, wherein
the first switch portion includes a changeover switch that changes a supply destination, to which the first power from the solar cell array is supplied, to the power conversion portion or to the first connection terminal.

10. The photovoltaic generation system according to claim 1, wherein
the power control portion includes a second terminal as an output terminal that is connected to an output side of the power conversion portion, and further comprises a second connection terminal that is connected to the second terminal; and
the alternative power control portion is connectable to the second connection terminal.

11. The photovoltaic generation system according to claim 1, wherein
the power control portion includes the second connection terminal and a second switch portion that is connected to the second terminal; and
the second terminal is connected to the second connection terminal, and the second connection terminal is connected to the power conversion portion via the second switch portion.

12. The photovoltaic generation system according to claim 1, wherein
the first connection terminal includes a dedicated connector.

13. The photovoltaic generation system according to claim 1, wherein
the alternative power control portion is loaded on a transportation means.

14. A power control device used for the photovoltaic generation system according to claim 1.

15. A collector device used for the photovoltaic generation system according to claim 1.

16. A power control device that includes a power conversion portion which converts first power from a plurality of solar cell modules into second power, comprising:
a first connection terminal that is supplied with the first power from the plurality of solar cell modules;
a first switch portion that shuts off the first power from the plurality of solar cell modules for the power conversion portion; and
an alternative power control device is connectable to the first connection terminal.

17. A collector device that comprises a plurality of input terminals to which power from a plurality of solar cell modules is input in parallel, a plurality of output terminals whose number is smaller than a number of the plurality of input terminals, and a first switch portion that shuts off the power from the plurality of solar cell modules for the output terminals, further comprising:
a first connection terminal that is connected to the output terminals via the first switch portion; and
an alternative power control device is connectable to the first connection terminal.
